(19) United States
(12) Patent Application Publication
(10) Pub. No.: US 2006/0109262 A1
(43) Pub. Date: May 25, 2006

(54) Structure of mouse pen

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/991,496

(22) Filed: Nov. 19, 2004

(51) Int. Cl. G09G 5/00

(52) U.S. Cl. 345/179

(57) ABSTRACT

An improved structure of a mouse pen is disclosed. The mouse pen mainly comprises a hollow pen shaft inside which a refill having a spring is mounted. A pen cover for press is mounted on a distal end of the pen shaft. A cursor control device is mounted on the pen shaft beside the pen point. An optical mouse circuit board having a wireless transmission circuit and a Bluetooth chip module is mounted inside the pen shaft. Furthermore, a refill is connected to the optical mouse circuit board via a sensor. As a result, the mouse pen structure is a pen for use in handwriting input and an optical mouse for use in computer input, and synchronizes the handwriting input and the computer input. Moreover, the mouse pen structure can be applied to listen to digital music and answer the phone.

### BACKGROUND OF THE INVENTION

The present invention relates to an improved structure of a mouse pen with integrated functions, and the mouse pen is suitable for an input device of a desktop computer, a notebook computer, or the like.

Pen is a kind of very convenient tool. No matter whether computer is invented or not, the pen is not knocked out. Moreover, mouse is a kind of essential input device of the computer. The mouse is evolved from a conventional mechanical roller mouse into an optical mouse. However, the pen and the mouse are unrelated apparatuses. The common method is to prepare a draft through a pen and transform the handwritten draft into a computerized file through various input methods by means of a keyboard.

A tablet input panel and a tablet pen are recently disclosed, however they must be utilized in pairs, or the computer is replaced directly by a touch monitor, wherein the input operation is performed by using the tablet pen to touch the tablet input panel and the touch monitor. Nevertheless, only one of the aforementioned structures can be chosen. The major drawback of prior art is that it is unable to simultaneously provide capabilities of handwriting input and computer input by using a single apparatus.

Accordingly, the present inventor has been made diligent studies with a quiet mind to provide an improved structure of a mouse pen that synchronizes these inputs. This improved structure of the mouse pen is provided for the consumer in accordance with motivations of the present invention.

### SUMMARY OF THE INVENTION

The main purpose of the present invention is to provide an improved structure of a mouse pen that synchronizes handwriting input and computer input.

The another purpose of the present invention is to provide an improved structure of a mouse pen that mounts a media player inside a pen shaft and provides with the function of making audio or video recording, listening to music or taking a picture.

The still another purpose of the present invention is to provide an improved structure of a mouse pen that mounts a Bluetooth chip module inside a pen shaft.

According to the aforementioned purposes of the present invention, an improved structure of a mouse pen is disclosed. The mouse pen mainly comprises a hollow pen shaft inside which a refill having a spring, a media player, and an optical mouse circuit board are mounted, wherein a wireless transmission circuit and a Bluetooth chip module are mounted on the circuit board. A push part to be pushed and a pen cover for covering a connector of the media player are mounted on the distal end of the pen shaft. Moreover, a cursor control device, a plurality of function buttons, a microphone, a camera lens, and a storage device slot are mounted on the periphery of a shaft body of the pen shaft. A refill is connected to the optical mouse circuit board via a sensor. As a result, the mouse pen structure is a pen for use in handwriting input and an optical mouse for use in computer input, and synchronizes the handwriting input and the computer input. Moreover, the mouse pen structure can be applied to listen to digital music and answer the phone.

The other features and preferred embodiments of the present invention will now be described with reference to the accompanying drawings.

### BRIEF DESCRIPTION OF THE DRAWINGS

FIG. 1 is a schematic view showing perspective appearance of a preferred embodiment of the present invention.

FIG. 2 is a schematic view, which is taken along another direction, showing perspective appearance of the preferred embodiment of the present invention.

FIG. 3 is a schematic view showing the use of the preferred embodiment of the present invention.

FIG. 4 is a schematic view showing perspective appearance of a second preferred embodiment of the present invention.

FIG. 5 is a schematic view, which is taken along another direction, showing perspective appearance of the second preferred embodiment of the present invention.

### DETAILED DESCRIPTION OF THE PREFERRED EMBODIMENT

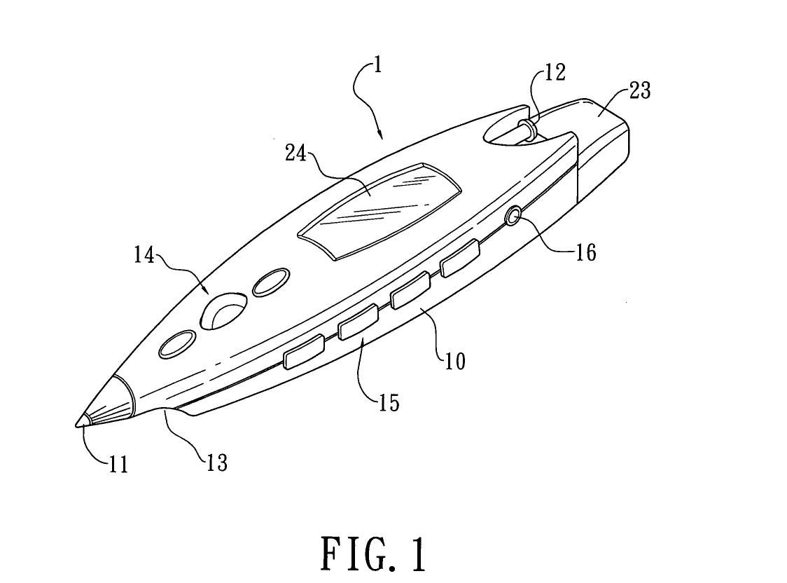

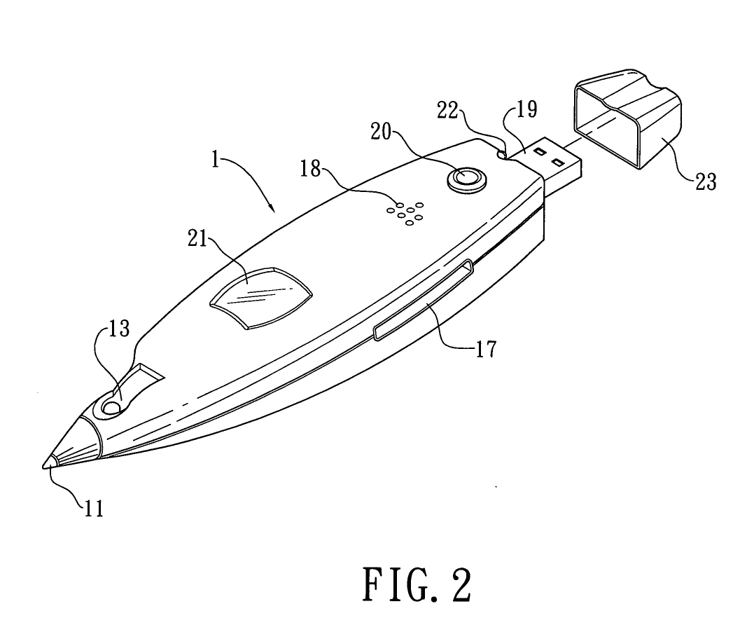

Referring to FIG. 1 and FIG. 2, a mouse pen structure 1 of the present invention mainly comprises a hollow shaft 10. On one end of the shaft 10 a constricted hole is formed for receiving a refill on which a spring is mounted. In addition, a push part 12 is mounted on a distal end of the shaft 10. By pressing the push part 12, a pen point 11 of the refill is able to extend from or shrink into the shaft 10 so as to provide the shaft 10 with writing function of pen. A recessed portion 13 is formed in a proper position beside the constricted hole of the shaft 10. A circuit board, which comprises an optical mouse circuit, a wireless transmission circuit, a character recognizing system, and a Bluetooth chip module, and a media player are mounted inside the shaft 10, wherein a LED light of the optical mouse is exactly mounted in the recessed portion 13. Besides, a sensor and an image detector are mounted inside the recessed portion 13. A USB connector 19 for connection the media player with a computer is mounted on the distal end of the shaft 10. The USB connector 19 is covered with a protection cover 23 to protect thereof. A cursor control device 14, a monitor 24, a storage device slot 17, an earphone jack 16, a camera lens 20, a microphone 18, and a plurality of function buttons 15 are mounted on the body of the shaft 10.

Furthermore, the shaft 10 can further comprise an identifier 21 and a LED light 22. The cursor control device 14 of the above optical mouse comprises two buttons (left button and right button) and a roller. The identifier 21 is a radio frequency identification (RFID) system. The pen point 11 is extended from the shaft 10 by pressing the push part 12 so as to treat the mouse pen structure 1 of the present invention as a general handwriting tool. If it is to be used as a mouse, the light, which is emitted by the LED of the optical mouse mounted inside the recessed portion 13 of the shaft 10, can be used as a cursor of the optical mouse by pressing the push part 12 to shrink the pen point 11 into the shaft 10. At the same time, the control device controls the cursor of the optical mouse. The wireless transmission circuit on the circuit board transmits a signal, which is received by a computer apparatus that comprises a wireless receiving circuit.

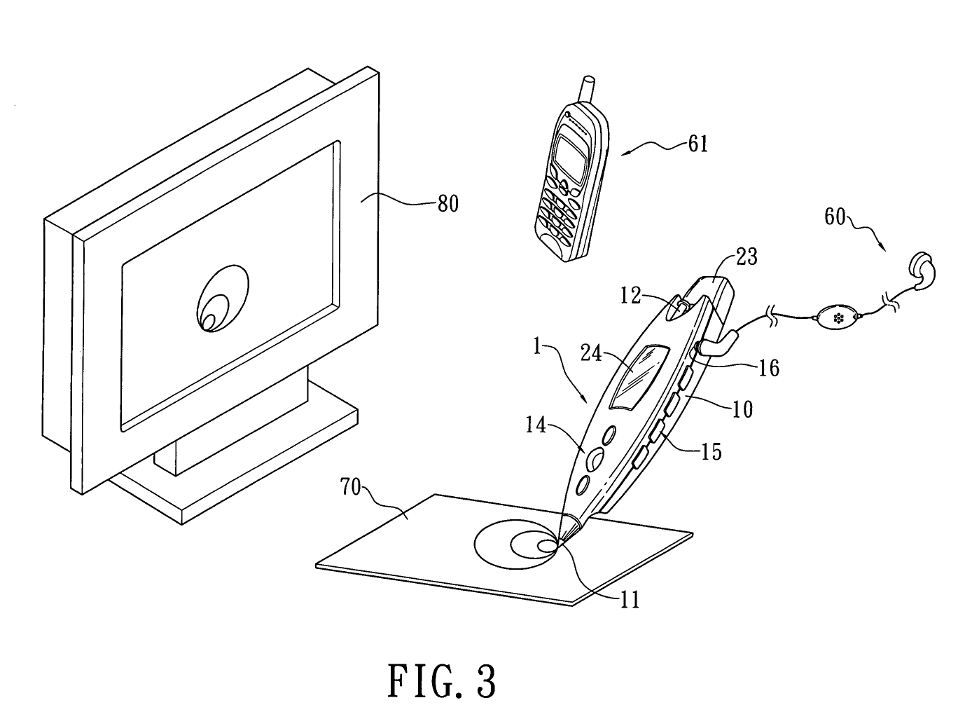

Besides, please refer to FIG. 3, a handwriting-input option is selected from input options of the computer apparatus so as to write and input characters. By means of pressing the push part 12, the pen point 11 is stretched out for writing characters on a paper surface 70. At this moment, the sensor mounted inside the recessed portion 13 performs the sensing step and actuates the optical mouse that moves synchronously with the pen point 11 for detecting length of a stroke of a character. In addition, the image detector mounted inside the recessed portion 13 utilizes an image overlay technique to recognize a position and an orientation of the stroke of the character. By means of the character recognizing system on the circuit board that mounts inside the shaft 10, the character that written through the pen point 11 can be inputted into the computer for synchronizing the handwriting input and the computer input. Besides, through an earphone 60 that plugs into the earphone jack 16, user is able to listen to digital music stored in the media player by pressing the function buttons 15 during the input operation described above. If there is an incoming call to the mobile phone 61, the Bluetooth chip module will perform a switch step automatically to answer the phone through the earphone 60, which is also a hand-free handset. When the writing function (e.g. handwriting input or computer input) of the mouse pen structure 1 is not adopted, the camera lens 20 of the mouse pen structure 1 of the present invention can be utilized to take a picture or make video recording. Moreover, the microphone 18 can be utilized to make an audio recording or the LED light 22 can be used as a pointer to present a briefing. Besides, the storage device slot 17 mounted on the mouse pen structure 1 can receive a storage device such as a memory card. The identifier 21 can be used as an entrance card. Furthermore, the mouse pen structure 1 can utilize the USB connector 19 to connect with the computer 80 for editing data that store in the media player and the storage device.

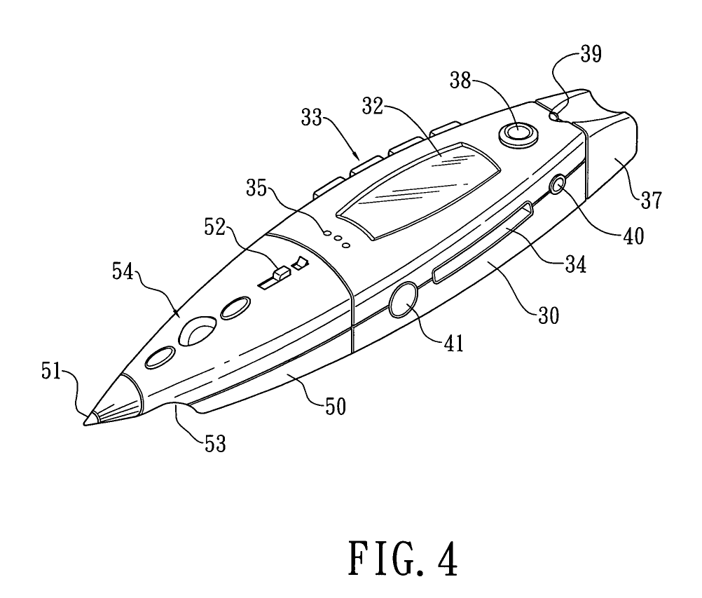

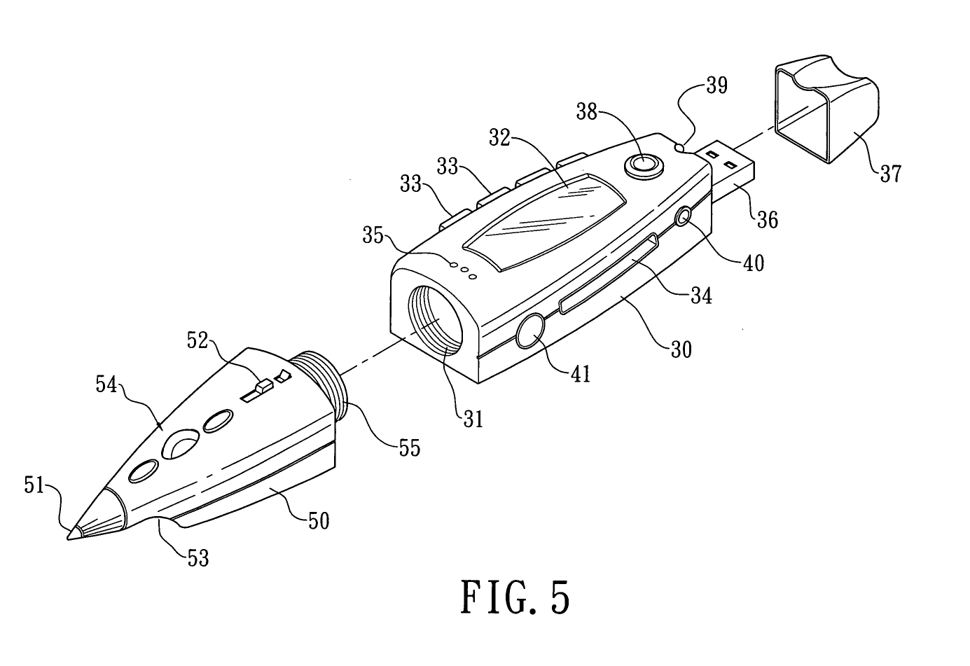

As shown in FIG. 4 and FIG. 5, a second preferred embodiment of the present invention comprises a mouse pen structure 50 and a media player 30, which are screwed to or demounted from one another by means of two connection parts 31 and 55. The mouse pen structure 50 comprises a short shaft inside which a refill that includes a spring is mounted. A shift button 52 is mounted on a distal end of the refill. By shifting the shift button 52, a pen point 51 of the refill extends from or shrinks into the short shaft. A recessed portion 53 is formed in a proper position beside the pen point 51 of the short shaft. A circuit board, which comprises an optical mouse circuit, a wireless transmission circuit, a character recognizing system, and a Bluetooth chip module, is mounted inside the short shaft, wherein a LED light of the optical mouse is exactly mounted in the recessed portion 53. Moreover, a sensor and an image detector are mounted inside the recessed portion 53. The sensor is connected to the refill for detecting length of a stroke of a character. The image detector is connected to a character recognizing system mounted on the circuit board to recognize a position and an orientation of the stroke of the character by utilizing an image overlay technique. A cursor control device 54 of the optical mouse is mounted on the body of the short shaft. The cursor control device 54 comprises a left button, a right button, and a roller. The distal end of the short shaft is further connected to a tail cover that comprises a connection part 55 on a top portion thereof.

The connection part 31 is embedded in the center position of the bottom portion of the media player 30. A LED light 39 is mounted beside the connection part 31. A USB connector 36 is mounted on a top portion of the media player 30. A protection cover 37 is mounted on the USB connector 36 for protection purpose. Moreover, a monitor 32, a plurality of function buttons 33, a storage device slot 34, a microphone 35, a camera lens 38, an earphone jack 40, and an identifier 41 are mounted on the periphery of the media player 30. As a result, the user is able to decide by himself to combine the mouse pen structure 50 with the media player 30 for use both of them or not. Alternatively, the media player 30 may be demounted from the mouse pen structure 50 in accordance with practical situation to reduce burden in user's hand when the mouse pen structure 50 is in use. If the user wants to go out, the media player 30 may be coupled with the mouse pen structure 50. Accordingly, the mouse pen is a tool for use in writing, music listening, and entrance control. Besides, the mouse pen is also adopted as a hand-free handset for a mobile phone.

As described above, it is apparent that the apparatus of the present invention comprises the following advantages.

1. The handwriting input and the computer input purposes are achieved synchronously when the present invention is applied to write down characters so as to obtain both a manuscript copy and a computer file after the writing procedure is finished.

2. The refill can be replaced when the refill is used up so as to continuously use the mouse pen structure.

3. When the present invention does not act as an input tool, it can be applied to listen to music, make audio and video recording, and be used as a laser pointer of briefing and an entrance card. It is also applied to answer the phone.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purpose of the present invention by providing an improved structure of a mouse pen with dual input functions. The application that complies with utility is therefore submitted for a patent.

What the invention claimed is:

1. An improved structure of a mouse pen comprising:
a hollow pen shaft inside which a refill having a spring, a media player, and a circuit board having an optical mouse circuit, a wireless transmission circuit, a character recognizing system, and a Bluetooth chip module are mounted; a push button for push and a protection cover for covering a connector of the media player mounted on a distal end of the pen shaft; a cursor control device, a plurality of function buttons, a microphone, a camera lens, an earphone jack, a recessed portion for receiving a LED light of an optical mouse, and a storage device slot mounted on the periphery of a shaft body of the pen shaft; and at least two sensors mounted inside the recessed portion, wherein one sensor is connected to the refill and the other sensor is connected to the character recognizing system such that a handwriting input and a computer input are synchronously accomplished when the mouse pen structure is utilized for an input purpose.

2. The improved structure of the mouse pen of claim 1, wherein an identifier, which is a radio frequency identification system, is mounted on the shaft body.

3. The improved structure of the mouse pen of claim 1, wherein a LED light, which is a briefing pointer, is mounted on the shaft body.

4. The improved structure of the mouse pen of claim 1, wherein the sensor, which is connected to the character recognizing system, recognizes a position and an orientation of a stroke of a character by utilizing an image overlay technique.

5. The improved structure of the mouse pen of claim 1, wherein a hand-free handset is plugged into the earphone jack on the shaft body so as to listen to digital music stored in the media player or answer the phone via the Bluetooth chip module.

6. An improved structure of a mouse pen comprising:
a mouse pen structure having a shaft body inside which a refill having a spring and a circuit board having an optical mouse circuit, a wireless transmission circuit, a character reading system are mounted, wherein a cover having a connection part on a top portion thereof is connected to a distal end of the shaft body, and a recessed portion for receiving a LED light of an optical mouse and at least two sensors, a cursor control device, and a refill shift part are mounted on the periphery of the shaft body, wherein one sensor is connected to the refill and the other sensor is connected to the character recognizing system; and
a media player having a connection part and a USB connector for connecting with a computer respectively on a bottom portion and a top portion thereof, wherein a Bluetooth chip module is mounted inside the media player and a monitor, a plurality of function buttons, a microphone, an earphone jack, a camera lens, and a storage device slot are mounted on the periphery of the media player such that the mouse pen structure and the media player are freely connected with or separated from one another by means of the connection parts.

7. The improved structure of the mouse pen of claim 6, wherein an identifier, which is a radio frequency identification (RFID) system, is mounted on the shaft body.

8. The improved structure of the mouse pen of claim 6, wherein the sensor, which is connected to the character recognizing system, recognizes a position and an orientation of the stroke of the character by utilizing an image overlay technique.

9. The improved structure of the mouse pen of claim 6, wherein a LED light, which is a briefing pointer, is mounted on the shaft body.

10. The improved structure of the mouse pen of claim 6, wherein a hand-free handset is plugged into the earphone jack of the media player so as to listen to digital music stored in the media player or answer the phone via the Bluetooth chip module.
